(19) United States
(12) Patent Application Publication
(10) Pub. No.: US 2025/0310974 A1
(43) Pub. Date: Oct. 2, 2025

(54) TIMING ADVANCE ALIGNED TRANSMISSIONS WITH RRC STATES

(71) Applicant: InterDigital Patent Holdings, Inc., Wilmington, DE (US)

(72) Inventors: Jongwoo Hong, New York, NY (US); Tao Deng, Roslyn, NY (US); Tuong Hoang, Montreal (CA); Martino Freda, Laval (CA); Benoit Pelletier, Roxboro (CA); Ghyslain Pelletier, Montreal (CA); Virgile Garcia, Antibes (FR)

(73) Assignee: InterDigital Patent Holdings, Inc., Wilmington, DE (US)

(21) Appl. No.: 18/623,640

(22) Filed: Apr. 1, 2024

(51) Int. Cl. H04W 72/25

(52) U.S. Cl. CPC H04W 72/25

(57) ABSTRACT

A wireless transmit/receive unit (WTRU) may comprise a processor configured for Timing Advance (TA) aligned aggregated uplink (UL) transmissions. The WTRU may be configured with a sidelink (SL) latency. The WTRU may receive a solicitation message, including a WTRU aggregation request, from a second WTRU. The request may include aggregation information, such as: a serving cell identification (ID), a SL latency threshold, a TA of the second WTRU, and/or a SL reference signal received power (SL-RSRP) threshold. The WTRU may transmit a response message to the second WTRU based on the aggregation information. The response message may indicate a capability to proceed with an aggregated UL transmission. The WTRU may receive a transmission from the second WTRU comprising one or more of: UL grant information, UL data, and/or the TA of the second WTRU. The processor may transmit the UL data using the UL grant information.

### BACKGROUND

Multiple wireless transmit/receive units (WTRU) may collaborate for transmission and/or reception. Applications of WTRU aggregation may be expanding in vertical direction such as (e.g., extended reality (XR), industrial internet of things (IoT), intelligent transportation systems, etc.). Some scenarios may impose service requirements utilizing reasonable resource and power efficiency. For example, ultra-high uplink (UL) data rate, ultra-low latency, and high reliability. Some services (e.g., XR, virtual/augmented reality (VR)/(AR)) may utilize synchronization among data flows from different devices (e.g., gloves, glasses, NR/6G IoT devices, etc.) running a single application layer. In some cases, a cellular network managing a service on a per WTRU basis may not satisfy the requirements for handling of multiple devices simultaneously.

### SUMMARY

A first wireless transmit/receive unit (WTRU) may comprise a processor configured for Timing Advance (TA) aligned aggregated uplink (UL) transmissions. The processor may be configured to receive configuration information comprising a sidelink (SL) latency. The processor may be configured to receive, via SL, a solicitation message from a second WTRU. The solicitation message may be a WTRU aggregation request comprising aggregation information. The aggregation information may be one or more of: a serving cell identification (ID) of the second WTRU, a SL latency threshold, a timing advance (TA) of the second WTRU, and/or a SL reference signal received power (SL-RSRP) threshold. The processor may be configured to transmit a response message to the second WTRU based on the aggregation information. The response message may indicate an acceptance of the WTRU aggregation request. The processor may be configured to receive a transmission from the second WTRU. The transmission may comprise uplink (UL) grant information, UL data, and/or the TA of the second WTRU. The processor may transmit the UL data using the UL grant information.

In examples, the aggregation information may comprise the SL-RSRP threshold. The processor may determine to transmit the response message based on a measured SL-RSRP of the solicitation message being greater than the SL-RSRP threshold. In examples, the aggregation information may comprise the serving cell ID associated with the second WTRU. The processor may determine to transmit the response message, based on the serving cell ID of the second WTRU being the same as a serving cell ID of the first WTRU. In examples, the aggregation information may comprise the SL latency threshold. The processor may determine to transmit the response message, based on the SL latency being less than the latency threshold. The UL data may be transmitted using the TA of the second WTRU if the first WTRU is an assistance WTRU having an idle or inactive RRC state. The UL data may be transmitted using the TA of the first WTRU if the first WTRU has a valid current TA value and is an assistance WTRU having a connected RRC state. The processor may be configured to change the RRC state of the first WTRU to a connected state prior to transmitting the UL data.

The processor may receive a preamble configuration, and may transmit a preamble to a network node. The preamble may comprise information associated with the acceptance of the WTRU aggregation request. The processor may be configured to receive, from the network node, a random access response (RAR). The RAR may indicate a TA value of the network node. The transmit timing of the preamble may be based on a synchronization signal block (SSB) corresponding to an indicated serving cell ID.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts an example Timing Advance (TA) command medium access (MAC) control element (MAC CE).

FIG. 3 illustrates an example of uplink (UL) aggregation for a group WTRUs in different radio resource control (RRC) states connecting via different serving cells.

FIG. 4 illustrates an example system flow diagram of TA alignment with a source WTRU.

FIG. 5 illustrates an example system flow diagram of preamble transmission for TA update and alignment with an assistance WTRU.

FIG. 6 illustrates an example system flow diagram of preamble transmission for TA update and alignment with a source WTRU.

FIG. 7 illustrates an example system flow diagram of group determination with a list of WTRU IDs.

FIG. 8 illustrates an example system flow diagram of group management for WTRU aggregation.

### DETAILED DESCRIPTION

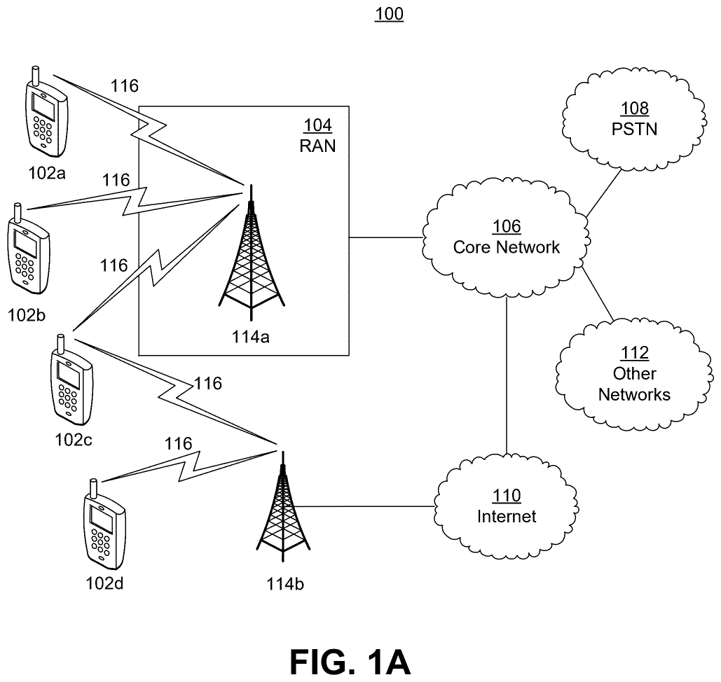

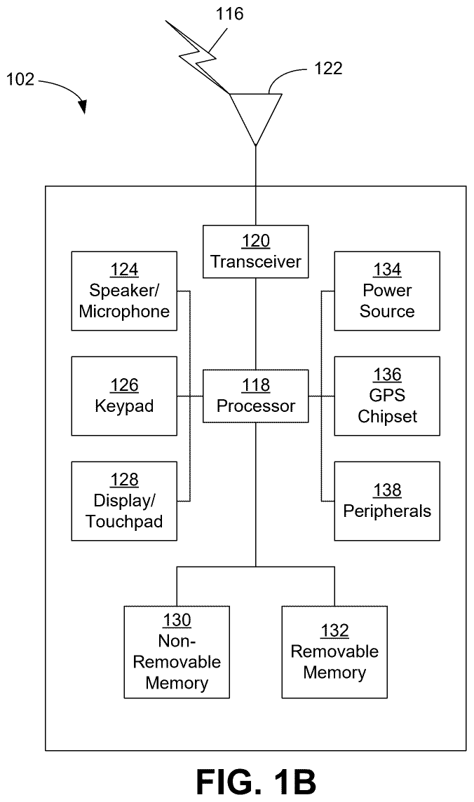

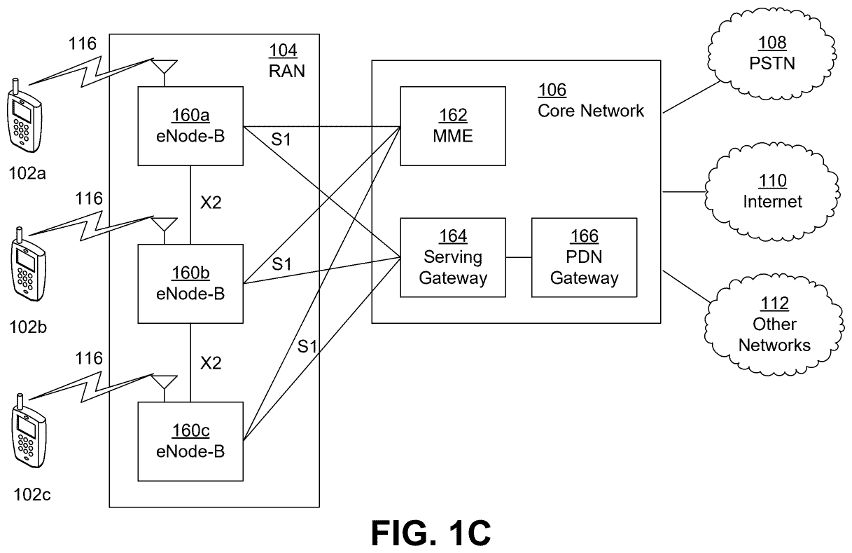

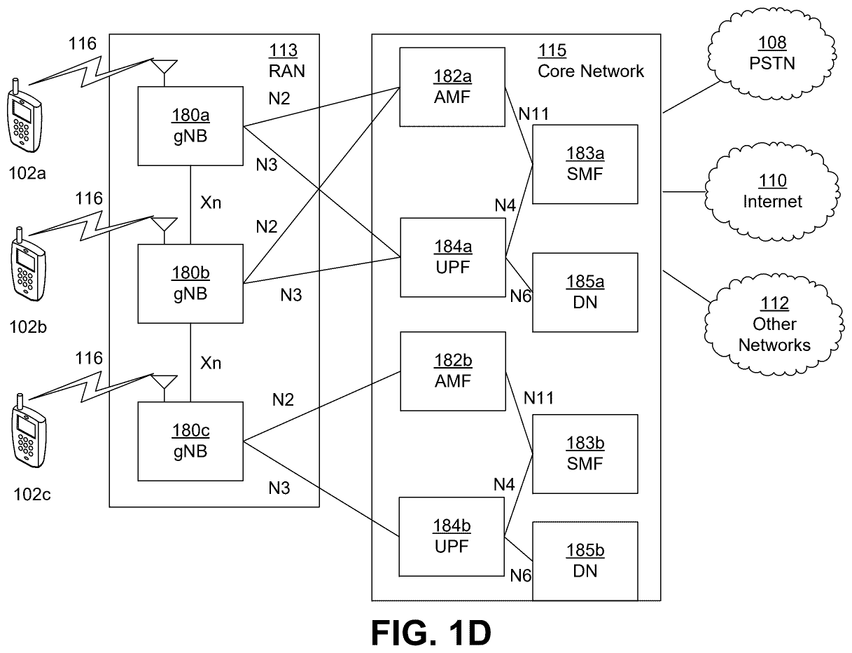

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHZ. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following abbreviations and acronyms, among others, may be used herein: Acknowledgement (ACK); Block Error Rate (BLER); Bandwidth Part (BWP); Channel Access Priority (CAP); Channel access priority class (CAPC); Channel Busy Ratio (CBR); Clear Channel Assessment (CCA); Control Channel Element (CCE); Control Element (CE); Configured grant or cell group (CG); Contention Window Size (CWS); Channel Occupancy (CO); Control Resource Set (CORESET); Channel Occupancy Time (COT); Cyclic Prefix (CP); Cyclic Prefix Extension (CPE); Conventional OFDM (relying on cyclic prefix) (CP-OFDM); Channel Occupancy Ratio (CR); Channel Quality Indicator (CQI); Cyclic Redundancy Check (CRC); Channel State Information (CSI); Contention Window (CW); Downlink Assignment Index (DAI); Downlink Control Information (DCI); Downlink feedback information (DFI); Dynamic grant (DG); Downlink (DL); Demodulation Reference Signal (DM-RS); PDU Radio Bearer (DRB); Hybrid Automatic Repeat Request (HARQ); Internet of Things (IoT); Logical Channel (LCH); Logical Channel Prioritization (LCP); Long Term Evolution e.g. from 3GPP LTE R8 and up (LTE); Negative ACK (NACK); Modulation and Coding Scheme (MCS); Maximum Data Burst Volume (MDBV); Multiple Input Multiple Output (MIMO); New Radio (NR); Orthogonal Frequency-Division Multiplexing (OFDM); Protocol Data Unit (PDU); Packet Delay Budget (PDB); Packet Error Rate (PER); Physical Layer (PHY); Public Land Mobile Network (PLMN); Process ID (PID); Paging Occasion (PO); Physical Random Access Channel (PRACH); Physical Sidelink Control Channel (PSCCH); Physical Sidelink Feedback Channel (PSFCH); Primary Synchronization Signal (PSS); Physical Sidelink Shared Channel (PSSCH); Random Access (or procedure) (RA) Random Access Channel (RACH); Random Access Response (RAR); Radio Bearer (RB); Radio access gNB Central Unit (RCU); Radio Front end (RF); Radio Link Failure (RLF); Radio Link Monitoring (RLM); Radio GNB Identifier (RNTI); RACH occasion (RO); Radio Resource Control (RRC); Radio Resource Management (RRM); Reference Signal (RS); Reference Signal Received Power (RSRP); Reference Signal Received Quality (RSRQ); Received Signal Strength Indicator (RSSI); Redundancy Version (RV); Sidelink Synchronization Signal Block (S-SSB); Sidelink Control Information (SCI); Service PDU Unit (SDU); Subframe Number (SFN); Sidelink (SL); Stand-alone Non-Public Network (SNPN); Sounding Reference Signal (SRS); Synchronization Signal (SS); Secondary Synchronization Signal (SSS); Switching Gap (in a self-contained subframe) (SWG); Semi-persistent scheduling (SPS); Supplemental Uplink (SUL); Timing Advance (TA); Transport Block (TB); Transport Block Size (TBS); Transmission/Reception Point (TRP); Time-sensitive communications (TSC); Time-sensitive gNBing (TSN); WTRU to Network Relay (U2N relay); Uplink (UL); Ultra-Reliable and Low Latency Communications (URLLC); Virtual Reality/Augmented Reality (VR/AR); Wide Bandwidth Part (WBWP); Wireless Local Area GNBs and related technologies (IEEE 802.xx domain) (WLAN); and Extended Reality (XR).

A WTRU may transmit a WTRU aggregation request in a sidelink (SL) message. The WTRU may transmit a WTRU aggregation request comprising: WTRU aggregation information, a serving cell ID, a timing advance (TA) of the source WTRU in the SL message. The WTRU may receive a SL message comprising a WTRU aggregation request from another WTRU. The WTRU may transmit a response message to accept the WTRU aggregation request (e.g., via SL) to the other WTRU. For example, the WTRU may transmit a response message to accept the WTRU aggregation request based on one or more of: the serving cell ID is the same as the cell ID indicated in the SL message; if the measured SL reference signal received power (SL-RSRP) is larger than the SL-RSRP threshold value indicated in the SL message; and/or if an SL and/or UL latency is smaller than the latency requirement indicated in the SL message. The WTRU may perform an UL data transmission using the received UL grant(s) and TA of the source.

Multiple WTRUs may collaborate for transmission and/or reception. Applications of WTRU aggregation may be expanding in vertical direction such as (e.g., extended reality (XR), industrial internet of things (IoT), intelligent transportation systems, etc.). Some scenarios may impose service requirements utilizing reasonable resource and power efficiency. For example, ultra-high uplink (UL) data rate, ultra-low latency, and high reliability. Some services (e.g., XR, virtual reality (VR)/(AR)) may utilize synchronization among data flows from different devices (e.g., gloves, glasses, NR/6G IoT devices, etc.) running a single application layer. In some cases, a cellular network managing a service on a per WTRU basis may not satisfy the requirements for handling of multiple devices simultaneously. To overcome such challenges, WTRU aggregation, in which multiple WTRUs collaborate for uplink transmission and downlink reception to boost the capability of the system may be considered.

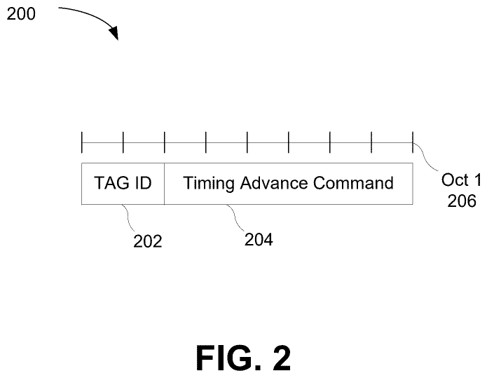

FIG. 2 illustrates an example TA command medium access (MAC) control element (MAC CE) 200. For RRC_CONNECTED, a gNB may be responsible for maintaining the timing advance to keep the L1 synchronized. Serving cells having uplink (UL) to which the same timing advance applies and/or using the same timing reference cell may be grouped in a TA group (TAG). The TA command MAC CE 200 may be identified by a MAC sub header with a LCID. The MAC sub header with a LCID may comprise an octet 206 (e.g., a single octet). The MAC sub header with a LCID may comprise a TAG Identity (TAG ID) 202. The TAG ID 202 may indicate the TAG Identity of the addressed TAG. A TAG with an Identity 0 may comprise the SpCell. In examples, the TAG ID 202 may have a field length of 2 bits. The TA Command 204 may indicate the index value TA (0, 1, 2 . . . 63), which may be used to control the amount of timing adjustment for a MAC entity to apply. In examples, the TA Command 204 may have a field length of 6 bits.

A cell (re-)selection procedure may comprise a RRC_IDLE state and a RRC_INACTVE state. The RRC_IDLE state and RRC_INACTIVE state tasks may be subdivided into a number (e.g., three) of processes. These processes may comprise one or more of: PLMN selection (for WTRU not operating in SNPN access mode) and/or SNPN selection (for WTRU operating in SNPN access mode); cell selection and reselection; and/or location registration and RNA update.

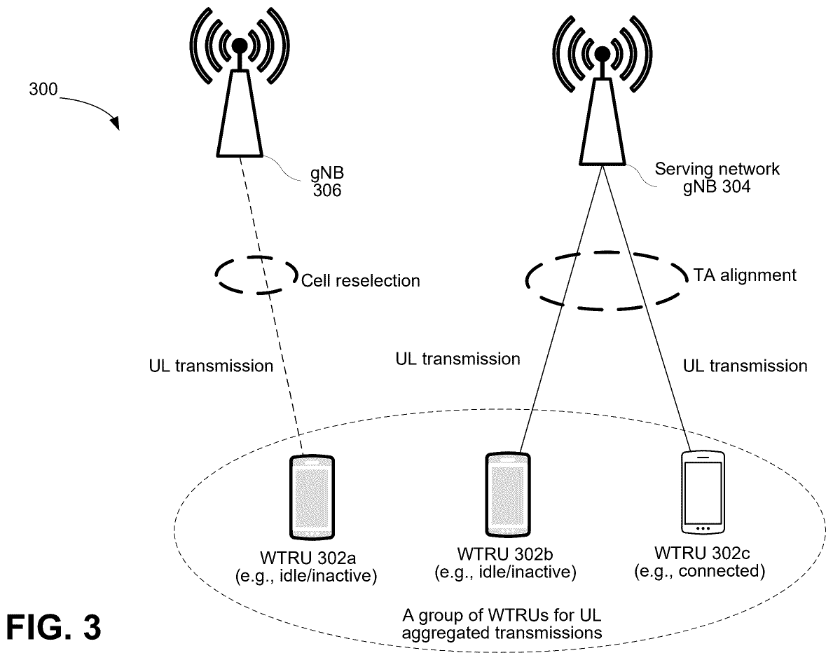

FIG. 3 illustrates an example of uplink (UL) aggregation 300 for a group WTRUs 302a 302b 302c in different radio resource control (RRC) states connecting via different serving cells. A WTRU 302a 302b 302c may go to idle state with an RRC state transition. In examples, the WTRU 302a 302b 302c may (e.g., autonomously) go to idle state, without an explicit message from a network. For example, the WTRU 302a 302b 302c may go to idle state based on one or more of: upon the expiry of data inactivity timer and/or upon expiry of a CG-SDT timer. The idle/inactive WTRU(s) 302a 302b may perform a cell (re-)selection procedure (e.g., WTRU 302a). To improve performance with aggregated UL transmissions, at least (M) aggregated UL transmissions from a group of WTRUs 302a 302b 302c may utilize the same serving cell. When one or more WTRUs 302a 302b are in RRC idle state among the group of WTRUs, some issues may be raised. For example, TAs of UL transmissions for WTRU aggregation may not be aligned among the group of WTRUs 302a 302b 302c (between connected WTRU(s) 302c and idle/inactive WTRUs 302b 302c). The serving network 304 may not be aware of whether the idle/inactive WTRU 302a 302b is currently camping on the same serving cell or not. If one of the group WTRU(s) (e.g., WTRU 302a) is camping to other cell (e.g., gNB 306), WTRU aggregation may result in further challenges (e.g., become infeasible).

A source WTRU may determine a group of TA aligned assistance WTRUs with different RRC states. The assistance WTRU (e.g., idle/inactive) may determine to perform aggregated UL transmission with alignment of the source WTRU's TA. The WTRU (e.g., source WTRU) may be configured to perform one or more of the following: The WTRU (e.g., source WTRU) may be (pre-)configured with WTRU aggregation information. WTRU aggregation information may comprise, for example, a required the number of aggregated transmissions (M), a latency requirement, and/or a SL-RSRP threshold. The WTRU may receive one or more UL grants for WTRU aggregation transmission. The WTRU may transmit a WTRU aggregation request in a SL solicitation message. The WTRU aggregation request may comprise WTRU aggregation information (e.g., serving cell ID, latency requirement, TA of the source WTRU, and/or SL-RSRP threshold). The WTRU may receive (N) SL response message(s) corresponding to the solicitation message. In examples, the WTRU may determine a group of assistance WTRUs for simultaneous transmission if the number of responses (N) is larger than the (M). The WTRU may transmit the received UL grant(s) and data, for example, via SL to assistance WTRU(s). The WTRU may perform UL data transmission(s) using the received UL grant(s), and report an indication of WTRU aggregation being enabled to the network. Alternatively or additionally, if M is larger than N, The WTRU may performs UL data transmission using the received UL grant(s), and reports an indication of WTRU aggregation being disabled to the network.

A WTRU (e.g., the assistance WTRU) may be configured to perform one or more of the following. The WTRU (e.g., assistance WTRU) may be (pre-)configured with a SL latency (e.g., via PC5 signaling). The WTRU may receive a SL solicitation message, which may include a WTRU aggregation request from the source WTRU. The WTRU aggregation request may comprise the aggregation information (e.g., serving cell ID, latency requirement, TA of the source WTRU and SL-RSRP threshold). In examples, the WTRU may determine to transmit a response based on one or more following conditions: the serving cell ID is the same as the cell ID indicated in the received message; the (pre-)configured latency is smaller than the latency requirement indicated in the received message; the current WTRU RRC state (e.g., connected/Idle/inactive) and/or validity of TA; and/or if a measured SL-RSRP on the solicitation message is larger than a SL-RSRP threshold value (e.g., the threshold indicated in the received message). The WTRU may transmit a response message to accept the WTRU aggregation request via SL to the source WTRU. The WTRU may receive UL data and/or grants via SL from the source WTRU. The WTRU may transmit one or more UL data transmissions. The transmissions may utilize the received UL grant(s) and TA of the source WTRU (e.g., in Idle/Inactive state) or a valid TA (e.g., in connected state).

The source WTRU, based on example procedures, may determine of a group of assistance WTRUs for aggregated UL transmissions. The assistance WTRUs may be in a (e.g., any) RRC state. In examples, with an alignment of TA of the source WTRU and same cell ID, the group of assistance WTRUs with a (e.g., any) RRC state may perform simultaneous TA aligned UL aggregated transmission(s) (e.g., with the same serving network).

There may be a source WTRU and/or an assistance WTRU. The source WTRU may initiate to transmit UL grant(s) to another WTRU (e.g., assistance WTRU). The source WTRU may initiate reception of UL grant(s) for WTRU aggregation from network. The source WTRU may initiate reception of a list of WTRU IDs for WTRU aggregation from network. The source WTRU may have UL and SL capability (e.g., PC5-S signaling, PC5-RRC setup, SL message transmission/reception).

The assistance WTRU may support another WTRU (e.g., source WTRU) for simultaneous UL transmission. The assistance WTRU may receive UL grant(s) and/or one or more parameters (e.g., TA value, cell ID) from another WTRU (e.g., source WTRU). The assistance WTRU may have UL and SL capability (e.g., PC5-S signaling, PC5-RRC setup, SL message transmission/reception).

Simultaneous transmission may be an SFN-based transmission(s) for performing aggregated/collaborated UL transmissions. For the simultaneous UL transmissions, one or more WTRU(s) (e.g., assistance WTRU) may transmit the same UL data with the same UL grant (e.g., using same time and frequency resource). The same UL data may comprise, for example, the same TB, RV, and/or MCS. If multiple WTRUs perform the UL simultaneous transmissions, the serving network (e.g., the gNB, serving cell, camping cell) may receive and combine UL data, TBs, and/or PDUs from one or more WTRUs involved in UL aggregated transmission(s) (e.g., SFN-based combining). For transmissions from multiple WTRUs, performance enhancements may be beneficial. For example, WTRU diversity gain, increased throughputs, and/or increased reliability for the UL transmission(s).

A WTRU (e.g., source WTRU) may receive an UL and/or SL configuration from the gNB and/or another WTRU (e.g., assistance WTRU). Also or alternatively, the source WTRU may be (pre-)configured. The source WTRU may receive a configuration from the gNB (e.g., dedicated RRC configuration or SIB). If the WTRU (e.g., source and/or assistance) receives a configuration from another node, the WTRU may receive the configuration via SL communication (e.g., PC5 RRC connection). The WTRU may transmit a PC5 signaling message (e.g., broadcast/unicast mode) to another WTRU. The WTRU (e.g., assistance WTRU) may receive a configuration via SL communication from another node (e.g., source WTRU). The WTRU (e.g., source WTRU) may be configured with one or more logical channels for UL aggregation transmissions. One or more of the logical channels associated with the UL data may be associated with a target reliability and/or a QoS (e.g., the required number of aggregated UL transmission (M).

The WTRU (e.g., source WTRU/assistance WTRU) may be connected via SL/PC5 interface between WTRUs. The WTRU may establish a PC5 unicast connection with another WTRU. If the PC5 unicast connection is established, the source WTRU and/or assistance WTRU may transmit a PC5 message (e.g., PC5-RRC reconfiguration) using the established PC5 unicast connection. Based on the established PC5-RRC connection, the WTRU may receive many parameters for UL aggregation transmissions from another WTRU. In examples, the parameters for UL aggregation transmissions may comprise: a TA value of the source WTRU, an updated TA value, UL data, an UL grant for aggregated UL transmissions, a serving cell ID, a SL-RSRP value for TA alignment, a latency requirement, a list of WTRU IDs, and/or preamble configuration for TA alignment.

SL discovery may be applied such that one or more WTRUs in proximity via PC5 interface may detect one or more other WTRUs. A WTRU may utilize SL discovery to find one or more WTRUs in proximity. If a transmitting WTRU sends a message via SL, a receiving WTRU may receive the message and may perform measurement(s) based on the received signal strength. There may be one or more types of discovery procedures using discovery signals and/or message (e.g., model A and model B). For Model A discovery, an announcing WTRU may send a SL positioning announcement message. For example, a WTRU may transmit and/or broadcast an announcement message to WTRUs in proximity (e.g., “I am a source WTRU”). For mode B discovery, the discoverer WTRU (e.g., that wants to find) may send a solicitation message (e.g., via broadcast, unicast mode). For example, the solicitation message may include a request to find an anchor WTRU. Upon receiving the solicitation message, the assistance WTRU may respond to the discoverer WTRU with the SL response message comprising information (e.g., “Here, I am an assistance WTRU”).

A WTRU (e.g., source WTRU) may determine and/or select a number of group of WTRUs (e.g., assistance WTRU(s)) for UL simultaneous transmission with the source WTRU. The utilized (e.g., required) number of WTRUs may be associated with a required number of aggregated UL transmissions (M). In examples, the required number of aggregated UL transmissions (M) may be based on throughput, reliability and/or required QoS. In examples, the WTRU (e.g., source WTRU) may determine a group of WTRUs (e.g., assistance WTRUs) when the number of responses (N) (e.g., acceptances of WTRU aggregation) from the WTRUs (e.g., assistance WTRUs) is larger than the required number of aggregated UL transmissions. The WTRU (e.g., assistance WTRU) may respond and/or accept WTRU aggregation request(s) from the WTRU (e.g., source WTRU) based on the one or more conditions. The WTRU (e.g., assistance WTRU) may be in RRC connected state, RRC inactive state, and/or RRC idle state.

As used herein, the following may be used interchangeably: “connected” and RRC connected state; “Idle” and RRC idle state; “inactive” and RRC inactive state; “TA” and TA value; and “SL” and PC5. As used herein, “another WTRU” may refer to either the source WTRU or the assistance WTRU, depending on context. A source WTRU may determine a group of TA aligned assistance WTRUs with different RRC states. The assistance WTRU may perform aggregated UL transmission with TA alignment of the source WTRU.

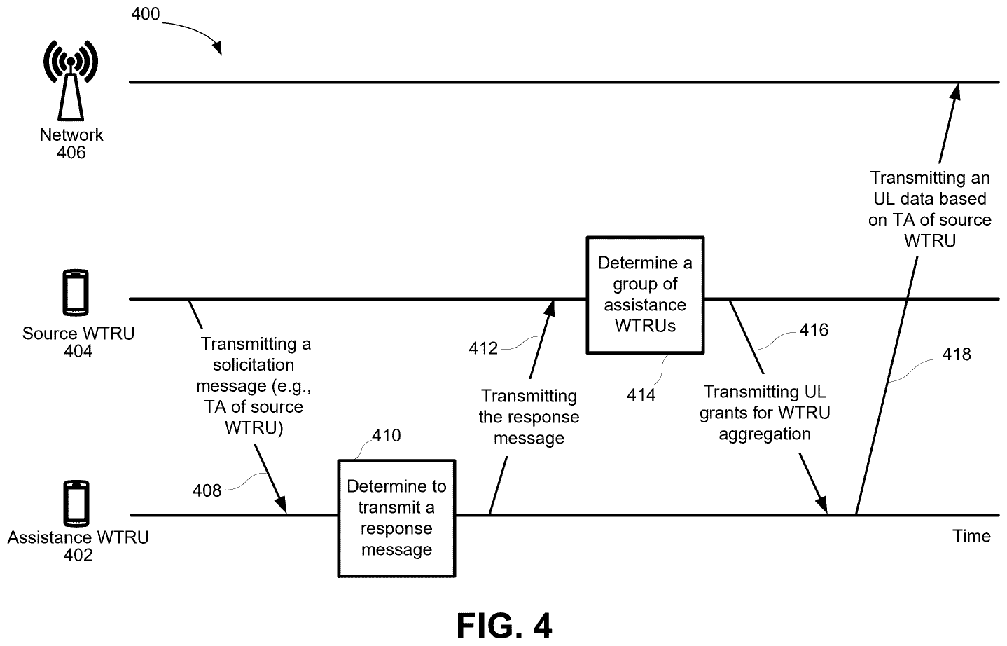

FIG. 4 illustrates an example system flow diagram 400 for TA alignment with a source WTRU 404. The source WTRU 404 may perform one or more of the following actions for TA alignment. The source WTRU 404 may be (pre-)configured with WTRU aggregation information. WTRU aggregation information may comprise, for example, an indicated (e.g., required) number of aggregated transmissions (M), a latency requirement, and/or a SL-RSRP threshold. The source WTRU 404 may receive one or more UL grants for WTRU aggregation transmissions. The source WTRU 404 may transmit at 408 a WTRU aggregation request in a SL solicitation message. The WTRU aggregation request may comprise WTRU aggregation information (e.g., serving cell ID, a latency requirement, TA of the source WTRU, and/or a SL-RSRP threshold). At 412, the WTRU 404 may receive (N) SL response message(s) corresponding to the solicitation message sent at 408. At 414, the source WTRU 404 may determine and/or select a group of assistance WTRUs (e.g., WTRU 402) based on the response message(s) received at 412. For example, the WTRU 404 may select a group of WTRUs for simultaneous transmission if the number of responses (N) is larger than the number of aggregated transmissions (M) indicated for by the aggregation information. At 416, the WTRU 402 may transmit the received UL grant(s) and data (e.g., via SL) to selected assistance WTRU(s) (e.g., WTRU 402). The source WTRU 404 may perform UL data transmission(s) using the received UL grant(s), and report an indication of WTRU aggregation being enabled to the network. In some cases, such as if M is larger than N, the source WTRU 404 may not transmit UL grants via SL, and transmit UL data using the UL grant(s) received from the network. In such cases, the source WTRU 404 may report an indication that WTRU aggregation is disabled to the network.

The assistance WTRU 402 may perform one or more of the following actions for TA alignment with a source WTRU 404. The assistance WTRU 402 may be (pre-)configured with a SL latency (e.g., via PC5 signaling). The WTRU 402 may receive a SL solicitation message from the source WTRU 404. The SL solicitation message, received by the WTRU 402 at 408, may comprise: a WTRU aggregation request and/or aggregation information (e.g., serving cell ID, latency requirement, TA of the source WTRU 402, and/or SL-RSRP threshold). In examples, the WTRU 402 may determine, at 410, to transmit a response based on one or more following conditions: the serving cell ID is the same as the cell ID indicated in the received message; the (pre-)configured latency is smaller than the latency requirement indicated in the received message; the current WTRU RRC state (e.g., connected/Idle/inactive); the validity of a TA; and/or if a measured SL-RSRP on the solicitation message is larger than a SL-RSRP threshold value (e.g., the threshold indicated in the SL solicitation message). The WTRU 402 may transmit to the source WTRU 404 a response message at 412 to accept the WTRU aggregation request (e.g., via SL). At 416, the assistance WTRU 402 may receive (e.g., via SL) UL data and/or grants (e.g., via SL) from the source WTRU 404. The WTRU 402 may transmit to the network 406 at 418, one or more UL data transmissions. The transmissions may utilize one or more of: the UL grant(s) received at 416, the TA of the source WTRU (e.g., in Idle/Inactive state), and a valid TA (e.g., in connected state).

A WTRU (e.g., a source WTRU) may determine to trigger the performance of UL aggregated transmission. In examples, the WTRU may be configured with one or more UL logical channels for WTRU aggregation from a serving network. If UL data is available from the configured one or more logical channels, and the channels are associated with UL aggregation transmission (e.g., high throughput/high reliability/UL QoS), the WTRU may determine to trigger UL transmission aggregation. To receive UL grant(s) for WTRU aggregation transmission, the source WTRU may transmit an indication (e.g., BSR and/or RRC message) to the serving network. The indication may comprise one or more indexes for the logical channel and/or logical channel group. After triggering the WTRU aggregation, the WTRU may transmit a SL solicitation message for determining a group of WTRUs for aggregated UL transmission.

The source WTRU may send a WTRU aggregation request. For example, the source WTRU may transmit a SL solicitation message comprising a request for aggregated UL transmission. The SL solicitation message may comprise the WTRU aggregation request, and one or more parameters. The parameters may be to be utilized by the other WTRU (e.g., assistance WTRU). In examples, the parameters may be utilized and/or checked to determine whether WTRU aggregation is feasible, or not. In examples, the WTRU (e.g., source WTRU) may transmit the solicitation message based on Model B. The WTRU may send the solicitation message, comprising the WTRU aggregation request, via broadcast transmission. If a WTRU receives the solicitation message, and the WTRU aggregation request, one or more WTRUs (e.g., assistance WTRU(s) may respond indicating for aggregated UL transmission.

The source WTRU may send the WTRU aggregation request comprising latency requirement parameter for one or more aggregated UL transmission grants. In examples, the latency requirement may indicate for dynamic UL grant(s). For example, a packet delay budget (PDB)) and/or configured UL grant(s) (e.g., starting offset from configured UL grant, periodicity of the configured UL grant). The latency requirement may be associated with one or more signaling, for example, the latency of PC5 signaling exchange/transmission/reception. The PC5 signaling exchange may comprise one or more of, for example: transmitting and/or receiving the solicitation message, PC5 RRC connection setup, PC5 RRC reconfiguration, WTRU aggregation accept and/or delivery time for UL data, and/or UL grant of aggregated UL transmission to another WTRU.

The connected WTRU (e.g., the source WTRU) may include a current TA value parameter for the group of WTRUs (e.g., assistance WTRUs) in the aggregation request. In examples, the idle/inactive WTRU may receive the TA value (e.g., via preamble transmission and RAR reception, RA procedure, UL RRC connection setup), and include the source WTRU's current TA value in a response message transmission for the group of WTRUs (e.g., assistance WTRUs).

In examples, the source WTRU may include a SL-RSRP threshold parameter for TA alignment/validity in the aggregation request. For example, the source WTRU may transmit a SL message and another WTRU (e.g., assistance WTRU) may receive the signal. If the measured received signal strength value of the SL message is above the threshold parameter value (e.g., SL-RSRP threshold), the WTRUs may determine that the WTRUs are located in proximity (e.g., distance). In examples, such as the WTRUs located in proximity, the WTRUs may determine that the TA value for both WTRUs to the serving network for UL transmission may be similar (e.g., within the cyclic prefix duration of UL transmission and/or within the extended cyclic prefix duration of UL transmission). In some cases, the assistance WTRU may reuse the same TA of the WTRU that transmitted the SL message (e.g., source WTRU).

The WTRU (e.g., source WTRU) may determine a group of WTRUs if the number of responses from the assistance WTRU is larger than the required number of aggregated UL transmissions (M). One or more responding assistance WTRUs may be in the RRC connected state, RRC inactive state, and/or RRC idle state.

The source WTRU may prioritize when determining WTRUs for selection for aggregated UL transmission. The source WTRU may prioritize selecting RRC connected state WTRUs for aggregated UL transmission. In examples, if the number of responses (N) is above the required number of aggregated UL transmission (M), the source WTRU may prioritize selecting RRC connected state WTRUs for aggregated UL transmission. For example, for a set of responses, the WTRU may first select/filter RRC connected WTRUs (e.g., based on prioritized selection rule), and then select idle/inactive assistance WTRUs. In one or more cases, the source WTRU may prioritize one or more WTRUs having an established PC5 connection between WTRUs. In examples, the number of responses (N) is above the required number of aggregated UL transmissions (M), the source WTRU may prioritize one or more WTRUs having an established PC5 connection between WTRUs. For example, while determining a group, the WTRU may first select/filters PC5 connection established WTRUs (e.g., based on prioritized selection rule), then may select other WTRUs (e.g., no PC5 connection).

The source WTRU may report an indication that WTRU aggregation has been disabled to the network. In examples, the source WTRU may report an indication of WTRU aggregation being disabled if the number of responses (N) from assistance WTRUs is below the indicated number (e.g., the required number of aggregated UL transmission (M). In examples, the WTRU may not select and/or determine a group of WTRUs for aggregated UL transmission (e.g., when receiving an UL grant, if the number of responses (N) from WTRUs is below the required number of aggregated UL transmission (M)). In examples, the WTRU may report WTRU aggregation has been disabled to the serving network, and the WTRU may receive one or more UL grants with configured repetitions. In some cases, the WTRU may perform the UL transmission utilizing repetitions to achieve the a desired QoS (e.g., relatively high reliability) if, for example, UL aggregated transmission capability is not available.

An assistance WTRU may transmit a response to a WTRU aggregation request. The assistance WTRU may receive a WTRU aggregation request message from the source WTRU (e.g., via SL solicitation message). The assistance WTRU may determine to and transmit, to the source WTRU, a response to the WTRU aggregation request. In examples, the WTRU may determine to respond based on the serving/camping cell ID may be the same for the assistance WTRU is same and that received the SL solicitation message. In examples, the WTRU may determine to respond based on the measured signal strength (e.g., SL-RSRP, SL-beam, SL-CSI, SL reference signal, specific SL reference signal) of the SL message (e.g., solicitation message) may be above the threshold value. The assistance WTRU may reuse the same TA of the WTRU that transmitted the SL solicitation message transmitted. For example, one or more WTRUs may determine that the WTRUs are located in proximity (e.g., distance) and may assume a similar TA value for the WTRUs. For example, the WTRUs may determine that the TA values may be aligned (e.g., at least) for: UL transmission timing within the cyclic prefix duration of UL transmission, and/or the extended cyclic prefix duration of UL transmission of UL data/PDU/TB. In examples, the assistance WTRU may be in the RRC connected state with a valid current TA value. In this case, the WTRU may use its own TA value for aggregated UL transmissions.

A WTRU may indicate a cause value associated with aggregated UL transmission. In examples, an idle/inactive assistance WTRU may change RRC state (e.g., to connected state from RRC idle/inactive state) for performing aggregated UL transmission. The WTRU may set up and establish a Uu RRC connection and/or resume the suspended Uu RRC connection. The WTRU may set a cause value, and may include the setting cause value in the RRC message. In examples, the WTRU may include an RRC setup cause value (e.g., WTRU aggregation request) during the RRC connection setup. For example, the WTRU may set the establishmentCause and/or resumeCause as WTRU aggregation request. The serving network may receive the cause value during RRC connection, and release Uu RRC connection when the aggregated UL transmission is completed.

A source WTRU may determine and/or select a group of TA aligned assistance WTRUs with different RRC states for transmission aggregation. The assistance WTRU(s) may determine to perform preamble transmission, and may receive an updated TA value.

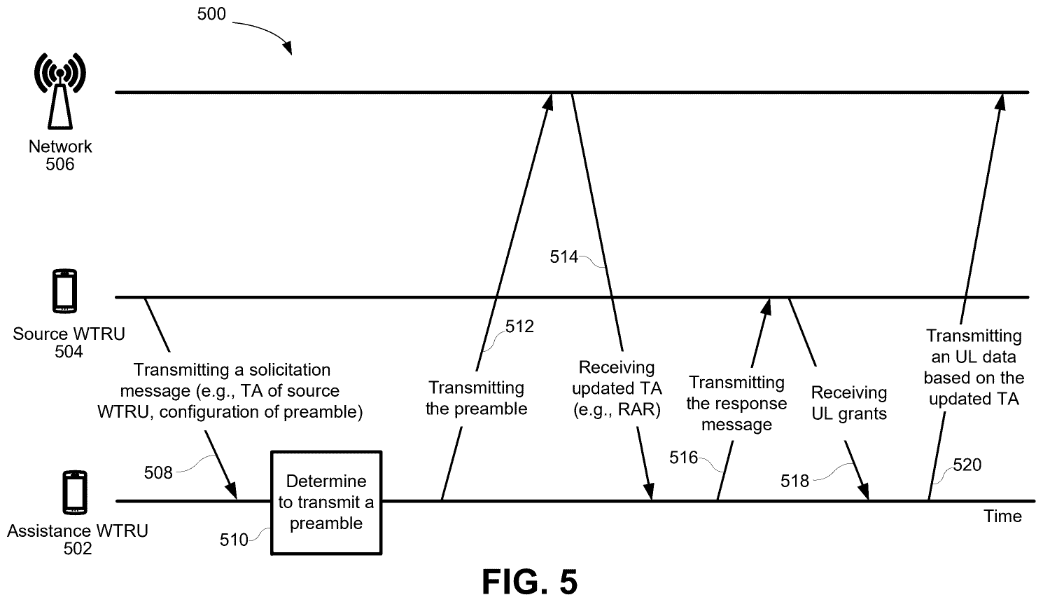

FIG. 5 illustrates an example system flow diagram 500 of preamble transmission for TA update and alignment with an assistance WTRU 502. The source WTRU 504 may perform one or more of the following actions for a preamble transmission, and TA update and alignment with an assistance WTRU. The source WTRU 504 may be (pre-)configured (e.g., by the network 506) with WTRU aggregation information. For example, the source WTRU 504 may be configured with aggregation information comprising one or more of: a required number of aggregated transmissions (M), a latency requirement, and/or a SL-RSRP threshold. The WTRU 504 may receive one or more UL grants for WTRU 504 aggregation transmission from the network 506. At 508, the WTRU 504 may transmit a WTRU a SL solicitation message comprising a WTRU aggregation request to assistance WTRU 502. The WTRU aggregation request may comprise one or more of, for example, WTRU aggregation information, a serving cell ID, TA of the source WTRU, and/or preamble transmission configuration (e.g., preamble resource, power level). At 516, the WTRU 504 may receive a SL response message(s) corresponding to the solicitation message sent at 508. The WTRU 504 may determine a group of assistance WTRUs for simultaneous transmission if, for example, the number of responses (N) is larger than the (M). The WTRU 504 may transmit, at 518, the received UL grant(s) and data (e.g., via SL) to determined assistance WTRU 502. The WTRU 504 may transmit UL data using the received UL grant(s), and may report an indication of WTRU aggregation being enabled to the network 506. In examples, the WTRU 504 may transmit UL data using the received UL grant(s), and report an indication that WTRU aggregation is disabled to the network 506.

The assistance WTRU 502 may perform one or more of the following actions for a preamble transmission and TA update and alignment. The assistance WTRU 502 may be (pre-)configured with SL and/or Uu latency (e.g., PC5 signaling exchange, Uu preamble transmission, and/or RAR reception). The assistance WTRU 502 may receive a SL solicitation message at 508 comprising a WTRU aggregation request from the source WTRU 504. The WTRU aggregation request may comprise the aggregation information (e.g., SL-RSRP threshold, a latency requirement, serving cell ID, TA of the source WTRU, and/or preamble transmission configuration). The WTRU 502 may determine at 510 to transmit a preamble at 512. For example, the WTRU 502 may determine to transmit the preamble at 512 based on one or more following conditions: the WTRU is in idle/inactive state; the serving cell ID is the same as the cell ID indicated in the received message; the measured SL-RSRP of the solicitation message is smaller than SL-RSRP threshold indicated the received message; and/or the (pre-)configured latency is smaller than the latency requirement indicated in the received message.

The WTRU may transmit the preamble at 512 using the preamble transmission configuration (e.g., preconfigured by the network 506 and/or received from the source WTRU at 508). In examples, the transmit timing may be based on the SSB corresponding to the indicated serving cell ID. At 514, the WTRU 502 may receive from the network 506, a random access response (RAR) comprising a TA value. The WTRU 502 may transmit a response message (e.g., via SL) at 516 to the source WTRU 504. The response message sent at 516 may indicate the assistance WTRU 502 has accepted the WTRU aggregation request (e.g., received by the WTRU 502 at 508). At 518, the WTRU 502 may receive UL data/grants (e.g., via SL) from the source WTRU 504. The WTRU 502 may transmit UL data using the received UL grant(s) and TA indicated in the RAR received at 514.

A source WTRU may transmit a solicitation message to one or more assistance WTRU(s). The source WTRU may transmit a solicitation message comprising a WTRU aggregation request and one or more parameters (e.g., received from the serving network). The source WTRU may include in the SL solicitation message one or more parameters for another WTRU (e.g., the assistance WTRU) for TA update and alignment with the serving network. To receive one or more parameters for TA update, the WTRU (e.g., source WTRU) may receive one or more parameters from the serving network, for example, T-RNTI for TA update for a WTRU and/or common RNTI for TA update for a (sub) group WTRUs. In examples, the source WTRU may transmit a solicitation message comprising a configuration for preamble transmission. The configuration for preamble transmission may comprise one or more of:

dedicated/common preamble resource(s), a preamble resource configuration (e.g., periodicity), an initial transmission power level, a number of retransmissions, a ramping power level for the retransmission, a RAR monitoring timer, a waiting timer for TA update, and/or a dedicated/common T-RNTI.

The source WTRU may transmit a solicitation message comprising a latency requirement associated with TA update and alignment of the assistance WTRU and PC5 signaling exchange. For example, the latency requirement may comprise a latency preamble transmission and RAR reception. In examples, the latency requirement may comprise, for example, one or more of: an allowed time (e.g., a maximum), a number (e.g., a maximum) of retransmissions, and/or an allowed time and associated number of retransmissions. The indicated latency requirement may apply, for example, for TA update and alignment between reception of the preamble configuration to reception of the RAR. The latency requirement may comprise one or more PC5 signaling (e.g., latency of PC5 signaling exchange/transmission/reception). The PC5 signaling exchange may comprise, for example, one or more of the following: transmitting and/or receiving the solicitation message, PC5 RRC connection setup, PC5 RRC reconfiguration, WTRU aggregation accept, and/or delivery time for UL data/UL grant of aggregated UL transmission to another WTRU.

An idle/inactive WTRU (e.g., the assistance WTRU) may determine to perform preamble transmission based on one or more following conditions. For example, the assistance WTRU may perform preamble transmission if the received latency requirement is smaller than the periodicity preamble resource configuration. The WTRU may monitor the PDCCH based on the received one or more parameters (e.g., dedicated/common T-RNTI) from the WTRU (e.g., source WTRU). The WTRU (e.g., assistance WTRU) may receive RAR with updated TA value based on received T-RNTI.

In one or more cases, the assistance WTRU may determine not to transmit a response message to the source WTRU. For example, the assistance WTRU may determine not to transmit a response message based on, for example, one or more of the following conditions: the assistance WTRU did not receive an updated TA from the network after a number of preamble transmissions, a number of maximum preamble retransmissions, and/or a certain number of retransmissions; the periodicity of the configured preamble is longer than the latency requirement; the WTRU may not receive a RAR (e.g., after preamble transmission) within a contention resolution timer running and/or within the latency requirement and/or the waiting timer for TA update; and/or the source WTRU may report an indication of WTRU aggregation being disabled to the network (e.g., the number of responses from assistance WTRU is below than the required number of aggregated transmissions (M)).

The source WTRU may determine a group of assistance WTRU(s) for aggregated UL transmissions. The source WTRU may utilize the UL aggregation request and response to determine a group of WTRUs for the assistance WTRU in a RRC state (e.g., any RRC state). The TA value may be updated for a group of assistance WTRU (e.g., inactive/idle state) performing preamble transmission and receiving an RAR from network. Based on these TA updates, the group of assistance WTRU may perform simultaneous TA aligned UL transmission with the same serving network.

There may be a TA update and alignment from a source WTRU. A source WTRU may determine a group of TA aligned assistance WTRUs with different RRC states. The assistance WTRU(s) may determine to perform preamble transmission and receive updated TA value(s) from source WTRU.

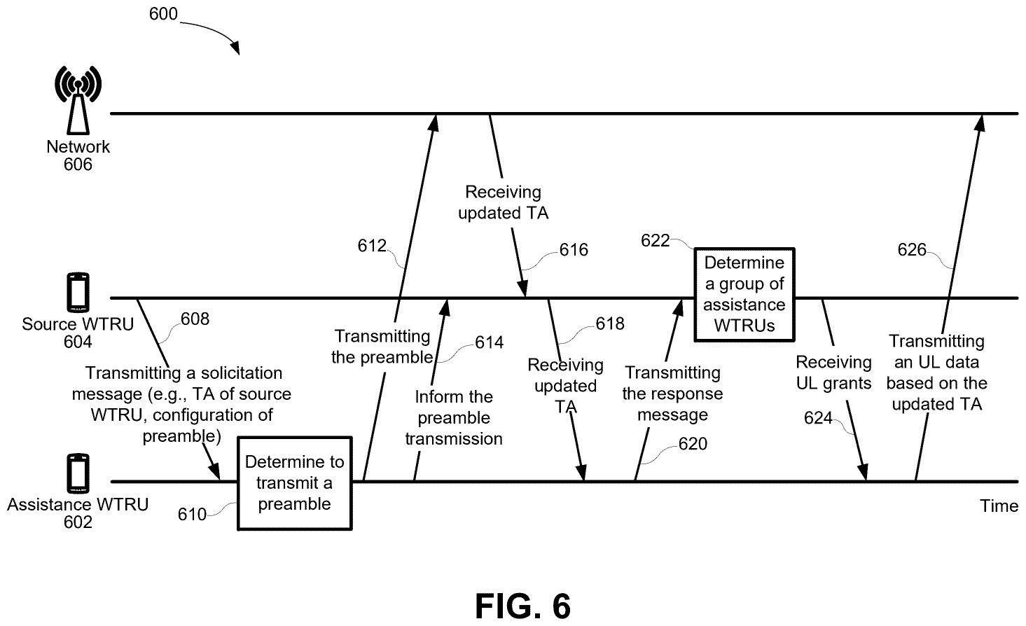

FIG. 6 illustrates an example system flow diagram 600 of preamble transmission for TA update and alignment from a source WTRU 604. The source WTRU 604 may perform one or more of the following actions for TA update and alignment with a source WTRU. The source WTRU 604 may be (pre-)configured with WTRU aggregation information. The WTRU aggregation information may comprise, for example, an indicated number of (e.g., required) aggregated transmissions (M), a latency requirement, and/or a SL-RSRP threshold. The WTRU 604 may receive one or more UL grants (e.g., from the network 606) for WTRU aggregation transmission. At 608, the WTRU 604 may transmit a SL solicitation message comprising a WTRU aggregation request. In examples, the WTRU aggregation request of the SL solicitation message may include WTRU aggregation information, serving cell ID, TA of the source WTRU 604, and/or preamble transmission configuration (e.g., preamble resource, power level). At 614, the assistance WTRU 602 may inform the source WTRU 604 (e.g., via SL) of a preamble transmission to the network 606. The source WTRU may receive updated TA values from the network 606 at 616. The WTRU 604 may transmit the updated TA values received at 616 from the network 606 to the assistance WTRU 602 at 618, indicating a preamble transmission in the response message. The source WTRU 604 may receive at 620 a SL response message corresponding to the solicitation message transmitted at 608. At 622, the WTRU 604 may determine a group of assistance WTRU(s) (e.g., WTRU 602) for simultaneous transmission. In examples, the WTRU 604 may determine a group of assistance WTRUs based on if the number of responses (N) received at 620 is larger than the indicated number of (e.g., required) transmissions (M). The WTRU 604 may transmit at 624 (e.g., via SL) the UL grant(s) and data received from the network 606 to determined assistance WTRU 602. The WTRU 604 may transmit UL data using the received UL grant(s), and report an indication of WTRU aggregation being enabled to the network 606. In some examples, the WTRU 604 may transmit UL data to the network 606 using the UL grant(s) received from the network 606, and report an indication of WTRU aggregation being disabled.

The assistance WTRU 602 may perform one or more of the following actions for a preamble transmission, and TA update and alignment with a source WTRU 604. The assistance WTRU 602 may be (pre-)configured with SL and/or Uu latency (e.g., PC5 signaling exchange and Uu preamble transmission and RAR reception). At 608, the assistance WTRU 602 may receive a SL solicitation message comprising a WTRU aggregation request from the source WTRU 604. The WTRU aggregation request received at 608 by the WTRU 602 may comprise the aggregation information (e.g., SL-RSRP threshold, a latency requirement, serving cell ID, TA of the source WTRU 604, and/or preamble transmission configuration). The WTRU 602 may determine at 610 to transmit a preamble. The WTRU 602 may determine to and transmit a preamble at 612 based on, for example, one or more following conditions: the WTRU 602 is in idle/inactive state; the serving cell ID is the same as the cell ID indicated in the message received; the measured SL-RSRP of the solicitation message is smaller than SL-RSRP threshold indicated the received message; and/or the (pre-)configured latency is smaller than the latency requirement indicated in the received message. The assistance WTRU 602 may transmit the preamble at 612 (e.g., using the received preamble transmission configuration). The WTRU 602 may inform the source WTRU 604 (e.g., via SL) of the preamble transmission at 614. The transmit timing of the preamble transmission at 612 may be based on, for example, the SSB corresponding to the indicated serving cell ID. The assistance WTRU 602 may receive a TA value from the source WTRU in a SL transmission at 618. The assistance WTRU 602 may transmit (e.g., via SL) a response message at 620 to accept the WTRU aggregation request from the source WTRU 604. The assistance WTRU 602 may receive UL data and/or grants (e.g., via SL) from the source WTRU 604. The assistance WTRU 602 may transmit UL data using the received UL grant(s) and TA indicated in the received SL transmission from the source WTRU.

A WTRU may transmit a SL message for preamble transmissions. A source WTRU may request and receive one or more parameters (e.g., periodicity of preamble/sequence, dedicated preambles, and/or dedicated power) for preamble transmissions for one or more WTRUs (e.g., assistance WTRU(s) of a serving network. Based on the received preamble configuration, the source WTRU may include, in a SL solicitation request, one or more parameters associated with preamble transmissions. The source WTRU may receive an updated TA from the serving network, and forward the updated TA to the one or more WTRU(s). That is, the source WTRU may receive the updated TA value from the serving network and transmit the updated TA value to one or more WTRU(s) via SL. For a TA value update, within a SL solicitation message comprising a WTRU aggregation request and/or one or more parameters, the source WTRU may include parameters associated with preamble configuration (e.g., received from the serving network) in the SL solicitation message for the group of assistance WTRU(s). In examples, the WTRU may request a dedicated/common TA value and preamble configuration for a specific WTRU and/or a group of WTRUs and/or a group of WTRUs in the same serving cell. This preamble configuration is applied for a specific WTRU and/or commonly used for a (sub-) group of WTRUs and/or a group of WTRUs in the same serving cell.

The source WTRU may include a latency requirement and/or parameter associated with a TA update and alignment of the assistance WTRU. For example, the latency parameter may comprise one or more of: a latency preamble transmission, a latency preamble retransmissions, maximum allowed time, timer value, time window, notification the preamble transmission, and/or receiving TA update from the WTRU (e.g., source WTRU). The latency requirement and/or parameter may be associated with one or more PC5 signaling. For example, the latency of PC5 signaling in question may be that of the exchange, transmission, and reception signaling exchange. The PC5 signaling exchange may comprise one or more of the following, for example: transmitting and/or receiving the solicitation message, PC5 RRC connection setup, PC5 RRC reconfiguration, WTRU aggregation accept, and/or delivery time for UL data/UL grant of aggregated UL transmission to another WTRU.

The idle/inactive WTRU (e.g., the assistance WTRU) may determine to perform a preamble transmission based on the received preamble configuration from another WTRU (e.g., via SL message). The preamble configuration may comprise one or more of the following parameters, for example: periodicity, dedicated preamble, transmission power, and/or transmission timing based on SSB with serving cell ID. In examples, the assistance WTRU may notify the source WTRU (e.g., via SL) of the preamble transmission.

The assistance WTRU may notify the source WTRU (e.g., via SL) of the preamble transmission following the preamble transmission of a TA value update for the source WTRU. The notification may comprise one or more of, for example: an index of transmitted preamble, a preamble transmission power, a number of retransmissions, a number of retransmissions, a transmitted power, a common T-RNTI, and/or a dedicated T-RNTI. The source WTRU may monitor the PDDCH and may receive a RAR from the serving network based on the notification from the assistance WTRU. The source WTRU may send the updated TA to the group of assistance WTRU (e.g., via the SL message).

A WTRU (e.g., the assistance WTRU) may determine not to transmit a response message to another WTRU (e.g., the source WTRU). For example, the assistance WTRU may determine not to respond to the source WTRU's SL solicitation request based on one or more of the following conditions: the WTRU did not receive the updated TA from the source WTRU after number of preamble transmissions; the periodicity of the configured preamble is longer than the latency requirement; the WTRU may not have received the updated TA within the latency requirement.

Preamble transmission for TA update and alignment from a source WTRU may enable a source WTRU to select and/or determine a group of WTRUs for aggregated UL transmissions for WTRU(s) in any RRC state (e.g., with UL aggregation request and response). preamble transmission for TA update and alignment from a source may enable a group of assistance WTRU(s) (e.g., inactive/idle state) to perform preamble transmission, the source WTRU may receive an RAR, updated TA value, and share the updated TA to the group of assistance WTRUs. Based on the updated TA, the group of assistance WTRU may perform simultaneous TA aligned UL transmission with the same serving network.

A list of WTRU IDs may be utilized for group determination. A source WTRU may determine and/or select a group of assistance WTRUs (e.g., with different RRC states) for WTRU aggregation based on a list provided by the network. An assistance WTRU may determine to perform an UL transmission based on the WTRU being included in the list and TA of the UL transmission being aligned with the source WTRU.

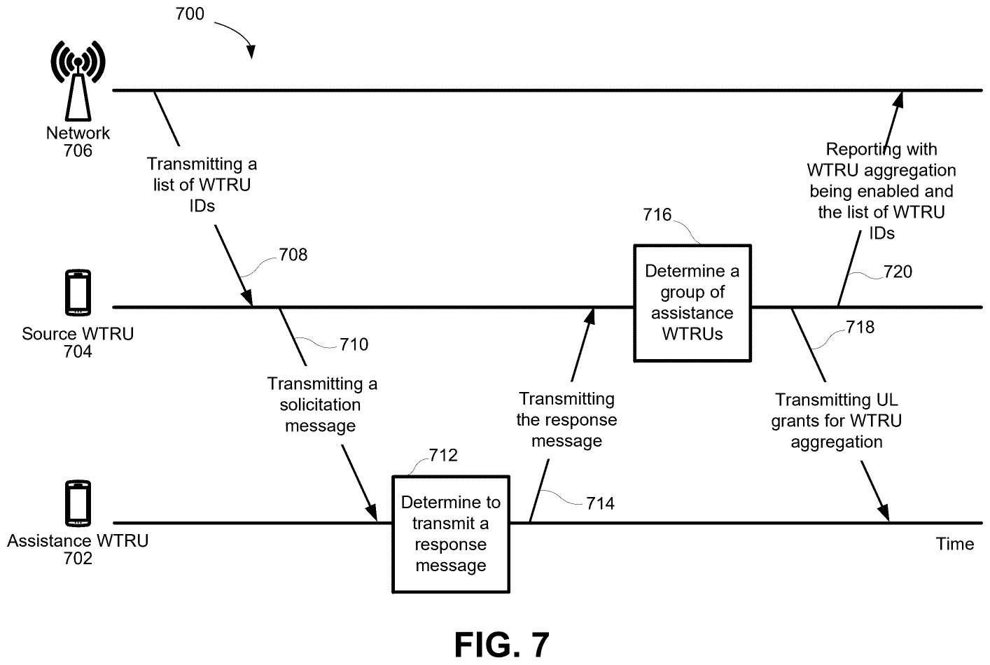

FIG. 7 illustrates an example system flow diagram 700 for group determination with a list of WTRU IDs. The source WTRU 704 may perform one or more of the following actions for group determination based on a list of WTRU IDs. The WTRU 704 may be (pre-)configured with WTRU aggregation information including, for example, a required number of aggregated transmissions (M)), a latency requirement, and/or a SL-RSRP threshold. At 708, the WTRU 704 may receive one of the following from the network 706: an indication of WTRU aggregation (e.g., enabled or disabled) with one or more grants (e.g., with repetitions); and/or a list of assistance WTRU IDs (e.g., Local IDs/L2 IDs) with RRC status of each WTRU and one or more UL grants. The WTRU 704 may transmit at 710 a SL solicitation message comprising a WTRU aggregation request. The request may comprise, for example, WTRU aggregation information, serving cell ID, TA of the source WTRU 704, and/or a list of WTRU IDs. At 714, the WTRU 704 may receive (e.g., via SL) a response message(s) corresponding to the solicitation message. The WTRU 704 may determine a group of assistance WTRUs for simultaneous transmission at 716 (e.g., if the number of responses (N) is larger than the (M)). The WTRU 704 may transmit at 718 the received UL grant(s) and data (e.g., via SL) to the determined assistance WTRU 702. The WTRU 704 may transmit at 720 to the network 706: UL data on the received UL grant(s), an indication of WTRU aggregation being enabled, and/or a list of assistance WTRU IDs for the network. In one or more examples, if the number of responses is less than (M), the WTRU 704 may report to the network 706: an indication of WTRU aggregation being disabled and/or a list of assistance WTRU IDs to the network. The WTRU 704 may receive one or more UL grants with multiple repetitions, and may send an UL transmission via the one or more UL grants with multiple retransmissions.

The assistance WTRU 702 may perform one or more of the following actions for group determination based on a list of WTRU IDs. The assistance WTRU 702 may be (pre-)configured with one or more WTRU IDs (e.g., Local ID, L2 ID) for WTRU aggregation. The assistance WTRU 702 may (pre-) configured with a SL and/or Uu latency (e.g., PC5 signaling exchange and RRC setup). At 710, the assistance WTRU 702 may receive a PC5 solicitation message for WTRU aggregation from the source WTRU 704. The WTRU aggregation request may include, for example, the aggregation information. The aggregation information may comprise one or more of: a SL-RSRP threshold, a latency requirement, a serving cell ID, a TA of the source WTRU 704, and/or preamble transmission configuration. The assistance WTRU 702 may determine at 712 to transmit a response message based on one or more of the following conditions: the WTRU 702 is in idle/inactive state; the WTRU ID is included in the list of WTRU IDs indicated in the received message; the serving cell ID is the same as the cell ID indicated in the received message; the (pre-)configured latency is smaller than the latency requirement indicated in the received message; and/or the measured SL-RSRP on the solicitation message is larger than SL-RSRP threshold value indicated in the received message. At 714, the WTRU 702 may transmit a response message comprising the associated WTRU ID, and indicating acceptance of the WTRU aggregation request (e.g., via SL to the source WTRU 704). The WTRU 702 may receive UL data/grants (e.g., via SL) from the source WTRU 704 at 718. For WTRU aggregation, the WTRU 702 may transmit UL data using the received UL grant(s) and/or a TA of the source WTRU 704 in Idle/Inactive state.

A WTRU (e.g., source WTRU) may utilize a list provided by the network for WTRU aggregation group determination. The WTRU may receive a list of WTRU IDs from the serving network. The list of WTRU IDs may comprise one or more ID types (e.g., WTRU ID, Prose L2 ID, Local ID, application ID). The list of WTRU IDs from the serving network may indicate an RRC status for each WTRU (e.g., connected, idle, inactive). The WTRU may be (pre-)configured with a list of WTRU IDs based on a service ID/application ID, for example, from an upper layer (e.g., application layer). A WTRU (e.g., source WTRU) may transmit the list of WTRU IDs (e.g., via a SL message) to an assistance WTRU. The assistance WTRU may receive the list of WTRU IDs, and determine to transmit a response message comprising the its own WTRU ID (e.g., the ID of the assistance WTRU) if the WTRU's ID is included and/or indicated in the received SL message or list.

A list of WTRU IDs (e.g., provided by the network) may assist in determining and/or selecting a group of assistance WTRUs for aggregated UL transmissions. For example, when the assistance WTRU is in an RRC state (e.g., any RRC state) with UL aggregation request and response. This operation may assist to group assistance WTRUs effectively (e.g., inactive/idle state) based on a list of WTRUs from network. In examples, the serving network may be aware of a group of assistance WTRUs, and manage WTRU simultaneous aggregated UL transmissions via a list.

With respect to group management for WTRU aggregation, a source WTRU may determine and manage a group of assistance WTRUs (e.g., with different RRC states) based on a request(s) and notification(s) exchange(s). The assistance WTRU may determine to notify the source WTRU if a condition is satisfied.

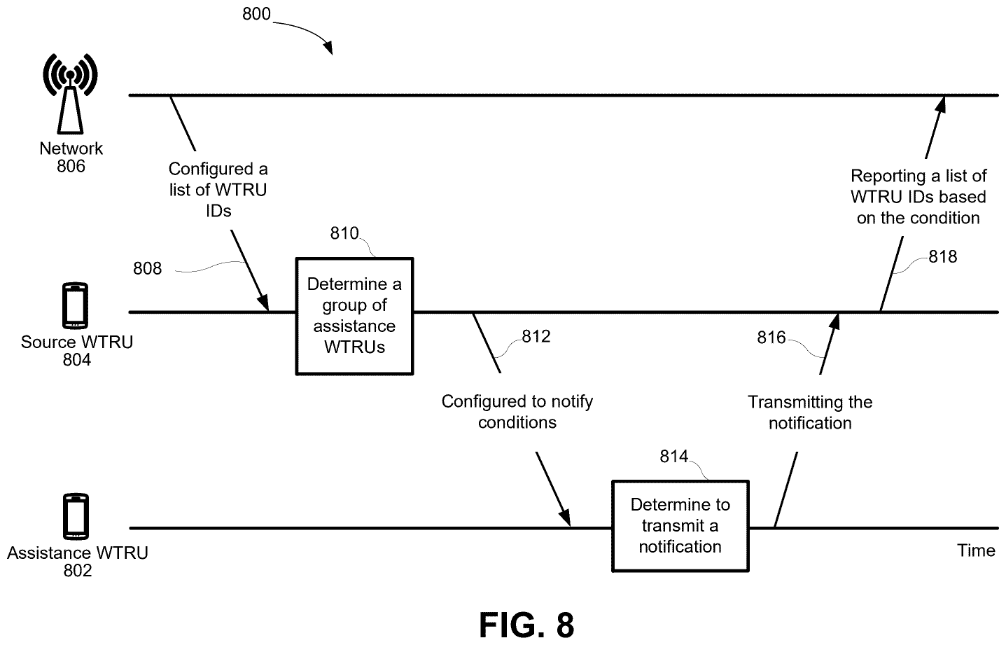

FIG. 8 illustrates an example system flow diagram of group management for WTRU aggregation. The source WTRU 804 may be configured to perform one or more of the following actions for WTRU aggregation group management. The WTRU 804 may be (pre-)configured with WTRU aggregation information including, for example, a required number of aggregated transmissions (M)), a latency requirement, and/or a SL-RSRP threshold. At 808, the WTRU 804 may receive a list of WTRU IDs (e.g., Local IDs/L2 IDs) from the network 806. At 810, the source WTRU 804 may determine a group of assistance WTRUs, and establish one or more PC5 connections with the group of assistance WTRUs based on the configured the list of WTRU IDs. The WTRU 804 may receive an update (e.g., periodic/event-based) request from the network 806. The update request may comprise one or more of: adding/removing one or more WTRU IDs; and/or indicating for the WTRU 804 to transmit a WTRU aggregation request in a SL solicitation message. The WTRU aggregation request may comprise WTRU aggregation information, a serving cell ID, and/or a TA of the source WTRU. The WTRU 804 may receive one or more responses from the assistance WTRU 802 and, in examples, establish (or release) one or more PC5 connections.

At 810, the WTRU 804 may determine a group of assistance WTRUs based on the responses from assistance WTRUs and/or update request from network, and report the group of the list of assistance WTRU IDs to the network. At 812, the WTRU 804 may configure the assistance WTRU 802 (e.g., transmit via SL) conditions to the assistance WTRU. The assistance WTRU 302 may be configured to notify the source WTRU based on one or more conditions. The WTRU 804 may be configured to notify to the group of assistance WTRUs with one or more of the following conditions for group management: the measured SL-RSRP value from the source WTRU is smaller than the threshold; and/or the current serving cell is different from the cell ID indicated in the solicitation message.

In response to the conditions, at 816 the WTRU 804 may receive one or more notifications from assistance WTRU(s) (e.g., WTRU 802), and may release one or more PC5 connection(s) with one or more assistance WTRUs. At 818, the WTRU 804 may report the list of assistance WTRU IDs if the number of the assistance WTRUs is below a number (e.g., the threshold (M)). The WTRU 804 may be reconfigured with WTRU aggregation information including, for example, a required the number of aggregated transmissions (K).

The assistance WTRU 802 may be configured to perform one or more of the following actions for WTRU aggregation group management. The WTRU 802 may establish a PC5 connection with the source WTRU 804. The WTRU 802 may be (pre-)configured with one or more WTRU IDs (e.g., Local ID, L2 ID) from the source WTRU 804. The WTRU 802 may receive a SL solicitation message comprising a WTRU aggregation request from the source WTRU 804. The WTRU aggregation request may comprise the aggregation information (e.g., serving cell ID, a latency requirement, TA of the source WTRU, and/or SL-RSRP threshold). The WTRU 802 may determine to transmit a response based on one or more of the following conditions: the serving cell ID is the same as the cell ID indicated in the received message; WTRU RRC state (e.g., connected, idle, inactive) and validity of TA; if the (pre-)configured latency is smaller than the latency requirement indicated in the received message; and/or if the measured SL-RSRP on the solicitation message is larger than SL-RSRP threshold value indicated in the received message. Upon transmitting the response message, being configured to notify with one or more conditions from the source WTRU 804 at 812. The WTRU may determine to transmit the notification to the source WTRU if at least one of the configured conditions is satisfied. The configured conditions may comprise, for example, the measured SL-RSRP value from the source WTRU is smaller than SL-RSRP threshold value indicated in the received message; and/or once the current serving cell is different from the cell ID indicated in the received message. At 816 the WTRU 802 may notify the WTRU 804 based on the configured conditions. Following transmission of the notification at 816, the PC5 connection may be released.

A WTRU (e.g., source WTRU) may receive a list of WTRU IDs from a serving network. The WTRU may be (pre-)configured with WTRU aggregation information including, for example, a (e.g., required) number of aggregated transmissions (M). The WTRU may establish one or more PC5 connections with one or more assistance WTRU(s) based on the received list of WTRU IDs. For example, the assistance WTRU may be stationary and may have no mobility. The source WTRU may configure a condition for triggering notification with one or more assistance WTRUs. The triggering notification may comprise one or more values, for example, a cell ID and/or SL-RSRP threshold.

The assistance WTRU may receive a SL transmission comprising a condition under which the assistance WTRU is to notify the source WTRU. In examples, the assistance WTRU may be configured to notify to the source WTRU when a measured SL-RSRP value is smaller than the configured SL-RSRP threshold value. In examples, the assistance WTRU may notify to the source WTRU when the measured SL-RSRP value is smaller than the configured SL-RSRP threshold value (e.g., SL-RSRP, SL-beam, SL-CSI, SL reference signal). The source WTRU may release a PC5 RRC connection upon receiving a notification from the assistance WTRU.

The source WTRU may report a list of WTRU IDs (e.g., assistance WTRUs) to the network. The source WTRU may report the list and request to (re-)configure the number of WTRUs for WTRU aggregation to the serving network. For example, the source WTRU may report the list to the network and request to (re-)configure the number of WTRUs if the number of WTRUs is below the (M) value. The source WTRU may be reconfigured for a number of aggregated transmissions (K). The network may determine the number of group WTRUs based on the received list of WTRU IDs. In examples, the number (K) may be a new (reconfigured) number for a group of WTRU for aggregated UL transmissions.

The source WTRU may be configured to manage a group of assistance WTRU(s) for aggregated UL transmissions. For example, the source WTRU may utilize one or more UL aggregation request and response(s) to manage assistance WTRU(s) in any RRC state. This may enable the group management of assistance WTRUs based on conditional notifications. In examples, the assistance WTRU may maintain a number (e.g., a certain number, configured number) of group of WTRUs for aggregated UL transmissions.

The invention claimed is:

1. A first wireless transmit/receive unit (WTRU) comprising:
a processor configured to:
receive configuration information comprising a sidelink (SL) latency;
receive, via SL, a solicitation message from a second WTRU, the solicitation message comprising a WTRU aggregation request and aggregation information, wherein the aggregation information comprises at least one of a serving cell identification (ID) of the second WTRU, a SL latency requirement, a timing advance (TA) of the second WTRU, or a SL reference signal received power (SL-RSRP) threshold;
transmit a response message to the second WTRU based on the aggregation information, the response message indicating an acceptance of the WTRU aggregation request;
receive a transmission from the second WTRU, the transmission comprising an uplink (UL) grant information, an UL data, and the TA of the second WTRU; and
transmit the UL data using the UL grant information.

2. The first WTRU of claim 1, wherein the aggregation information comprises the SL-RSRP threshold, and wherein the processor is configured to:
transmit the response message based on a measured SL-RSRP of the solicitation message being greater than the SL-RSRP threshold.

3. The first WTRU of claim 1, wherein the aggregation information comprises the serving cell ID of the second WTRU, and wherein the processor is configured to:
determine to transmit the response message, based on the serving cell ID of the second WTRU being the same as a serving cell ID of the first WTRU.

4. The first WTRU of claim 1, wherein the aggregation information comprises the SL latency requirement, and wherein the processor is configured to:
determine to transmit the response message, based on the SL latency being less than the SL latency requirement.

5. The first WTRU of claim 1, wherein:
the UL data is transmitted using the TA of the second WTRU if the first WTRU is an assistance WTRU having an idle or inactive RRC state; and
wherein the wherein the UL data is transmitted using a TA of the first WTRU if the first WTRU has a valid current TA value and is an assistance WTRU having a connected RRC state.

6. The first WTRU of claim 1, wherein the first WTRU is an assistance WTRU in an idle or inactive RRC state, and wherein the second WTRU is a source WTRU in a connected RRC state, wherein the processor is configured to change the RRC state to a connected state prior to transmitting the UL data.

7. The first WTRU of claim 1, wherein the aggregation information comprises a preamble configuration, wherein the processor is configured to:
transmit, to a network node, a preamble indicating information associated with the acceptance of the WTRU aggregation request, wherein the preamble is transmitted based on the preamble configuration, wherein the transmit timing of the preamble is based on a synchronization signal block (SSB) corresponding to an indicated serving cell ID.

8. The first WTRU of claim 7, wherein the aggregation information comprises the SL latency requirement and a Uu latency requirement, wherein the processor is configured to:
determine to transmit the response message, based on the sum of a Uu latency and the SL latency being less than the sum of the Uu latency requirement and the SL latency requirement.

9. The first WTRU of claim 7, wherein the processor is configured to:
receive, from the network node, a random access response (RAR), the RAR indicating an updated TA value.

10. The first WTRU of claim 7, wherein the processor is configured to:
receive the transmission from the second WTRU, wherein the transmission comprises an updated TA value and an indication of a preamble transmission.

11. A method implemented in a first wireless transmit/receive unit (WTRU) comprising:
receiving configuration information comprising a sidelink (SL) latency;
receiving, via SL, a solicitation message from a second WTRU, the solicitation message comprising a WTRU aggregation request and aggregation information, wherein the aggregation information comprises at least one of a serving cell identification (ID) of the second WTRU, a SL latency requirement, a timing advance (TA) of the second WTRU, or a SL reference signal received power (SL-RSRP) threshold;
transmitting a response message to the second WTRU based on the aggregation information, the response message indicating an acceptance of the WTRU aggregation request;
receiving a transmission from the second WTRU, the transmission comprising an uplink (UL) grant information, an UL data, and the TA of the second WTRU; and
transmitting the UL data using the UL grant information.

12. The method of claim 11, wherein the aggregation information comprises the SL-RSRP threshold, the method further comprising:
transmitting the response message based on a measured SL-RSRP of the solicitation message being greater than the SL-RSRP threshold.

13. The method of claim 11, wherein the aggregation information comprises the serving cell ID of the second WTRU, the method further comprising:
determining to transmit the response message, based on the serving cell ID of the second WTRU being the same as a serving cell ID of the first WTRU.

14. The method of claim 11, wherein the aggregation information comprises the SL latency requirement, the method further comprising:
determining to transmit the response message, based on the SL latency being less than the SL latency requirement.

15. The method of claim 11, wherein:
the UL data is transmitted using the TA of the second WTRU if the first WTRU is an assistance WTRU having an idle or inactive RRC state; and
the UL data is transmitted using a TA of the first WTRU if the first WTRU has a valid current TA value and is an assistance WTRU having a connected RRC state.

16. The method of claim 11, wherein the first WTRU is an assistance WTRU in an idle or inactive RRC state, wherein the second WTRU is a source WTRU in a connected RRC state, the method further comprising:
changing the RRC state of the first WTRU to a connected state prior to transmitting the UL data.

17. The method of claim 11, wherein the aggregation information comprises a preamble configuration, the method further comprising:
transmitting, to a network node, a preamble indicating information associated with the acceptance of the WTRU aggregation request, wherein the preamble is transmitted based on the preamble configuration, wherein the transmit timing of the preamble is based on a synchronization signal block (SSB) corresponding to an indicated serving cell ID.

18. The method of claim 17, wherein the aggregation information comprises the SL latency requirement and a Uu latency requirement, the method further comprising:
determining to transmit the response message, based on the sum of a Uu latency and the SL latency being less than the sum of the Uu latency requirement and the SL latency requirement.

19. The method of claim 17, further comprising:
receiving, from the network node, a random access response (RAR), the RAR indicating an updated TA value.

20. The method of claim 17, further comprising:
receiving the transmission from the second WTRU, wherein the transmission comprises an updated TA value and an indication of a preamble transmission.
